(19) United States
(12) Patent Application Publication
(10) Pub. No.: US 2016/0099930 A1
(43) Pub. Date: Apr. 7, 2016

(54) RESTRICTION OF IP ACCESS BASED ON PERSONAL PERFORMANCE

(71) Applicant: Nicholas James Minovski, Markham (CA)

(72) Inventor: Nicholas James Minovski, Markham (CA)

(21) Appl. No.: 14/508,649

(22) Filed: Oct. 7, 2014

(51) Int. Cl. H04L 29/06

(52) U.S. Cl. CPC H04L 63/083; H04L 63/105

(57) ABSTRACT

An application on a computing device communicatively coupled to a communications network for receiving restriction input from a parent user of the application. The application includes a reception module configured for receiving physical activity data from a wearable computing device worn by a child user. The application also includes an access control module configured for: receiving a request from the child user to access particular content on the communications network, comparing the received physical activity data from the wearable computing device to a physical activity threshold and determining whether the physical activity threshold has been met, comparing the particular content to the definition of accepted content, determining whether the particular content comprises accepted content, and, providing to the child user access to the particular content on the communications network if the particular content comprises accepted content and the physical activity threshold has been met.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of computing devices, and more specifically to the field of monitoring access to computing devices.

### BACKGROUND

With the proliferation and usage of mobile devices, children and young adults are spending more time online playing games, engaging in social media and streaming media, as opposed to using their device as an opportunity to absorb educational content. A direct side effect of the countless idle hours has also resulted in an unhealthy sedentary life style. Childhood obesity is now a serious U.S. public health problem. Today, nearly a third of youths are overweight or obese. That's more than 23 million children and teenagers. Consequently, many initiatives have been created to enable youths to become more active and lead a healthier lifestyle.

Healthy lifestyle habits, including healthy eating and physical activity, can lower the risk of becoming obese and developing related diseases. The dietary and physical activity behaviors of children and adolescents are influenced by many sectors of society, including families, communities, schools, child care settings, medical care providers, faith-based institutions, government agencies, the media, and the food and beverage industries and entertainment industries. One of the aspects of a child's life that has potential for positively affecting their health is computing devices.

Many parents purchase computing devices and computers for their children as a learning platform with hopes they will use the device for educational purposes. As time passes, however, children become less interested in performing learning activities on a computing device as it interferes with their desire to use the device to play video games or watch subject matter that is not appropriate. As a result, it becomes difficult for a parent or guardian to ensure a child is performing their learning activities on the computing device and/or watching appropriate subject matter. Further, as a child begins to spend a large amount of time in front of a computing device remaining idle, this can lead to ill health for the child. Various approaches to this problem have included setting timers on a computing device or other access restrictions. But all of said approaches simply restrict access to the computing device and do not address the health of the child that is accessing the device.

Therefore, there is a need to overcome the problems with the prior art, and more specifically, a need for a system and a device that restricts access to a computing device and facilitates maintenance of a child's health.

### SUMMARY

A method and system for restriction of Internet Protocol (IP) access based upon personal performance is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an application on a computing device communicatively coupled to a communications network, comprising a graphical interface for receiving restriction input from a parent user of the application, is disclosed. The restriction input includes a definition of a physical activity threshold and a definition of accepted content. The application further includes a reception module configured for receiving, via radio frequency or vendor application, physical activity data from a wearable computing device worn by a child user. The application also includes an access control module configured for receiving a request from the child user, via a graphical interface, to access particular content on the communications network. The access control module is also configured for comparing the received physical activity data from the wearable computing device to the physical activity threshold and determining whether the physical activity threshold has been met. The access control module is also configured for comparing the particular content to the definition of accepted content and determining whether the particular content comprises accepted content. The access control module is also configured for providing to the child user access to the particular content on the communications network if the physical activity threshold has been met and if the particular content comprises accepted content.

### BRIEF DESCRIPTION OF THE DRAWINGS

The accompanying drawings, which are incorporated in and constitute a part of this disclosure, illustrate various example embodiments. In the drawings:

FIG. 1 is a diagram of an operating environment that supports an application for restricting IP access based upon personal performance over a communications network, according to an example embodiment;

FIG. 2A is a flowchart showing the control flow of a process for restricting IP access over the communications network, according to an example embodiment;

FIG. 2B is a flowchart showing the control flow of a process for restricting IP access over the communications network, according to another example embodiment;

FIG. 3A is a block diagram showing the data flow of a process for restricting IP access over the communications network, according to another example embodiment;

FIG. 3B is a block diagram showing the data flow of a process for restricting IP access over the communications network, according to another example embodiment;

FIG. 4 is a block diagram showing the data flow of a process for restricting IP access over the communications network, according to another example embodiment;

FIG. 5 is a block diagram of a computing device, according to an example embodiment.

### DETAILED DESCRIPTION

The following detailed description refers to the accompanying drawings. Wherever possible, the same reference numbers are used in the drawings and the following description to refer to the same or similar elements. While the disclosed embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosed embodiments. Instead, the proper scope of the disclosed embodiments is defined by the appended claims.

The disclosed embodiments improve over the prior art by providing a system that facilitates maintaining the health of a child user by utilizing input from external sources to determine if physical activity goals or educational activity goals for the child have been achieved prior to allowing access to IP destinations. Further, the disclosed embodiments allow parents to enforce daily physical activity requirements and daily learning goals of a child user even when the parent is not present to enforce such requirements and goals. The disclosed embodiments further improve over the prior art by providing a system that facilitates enforcement of restrictions on the content being viewed by the child user.

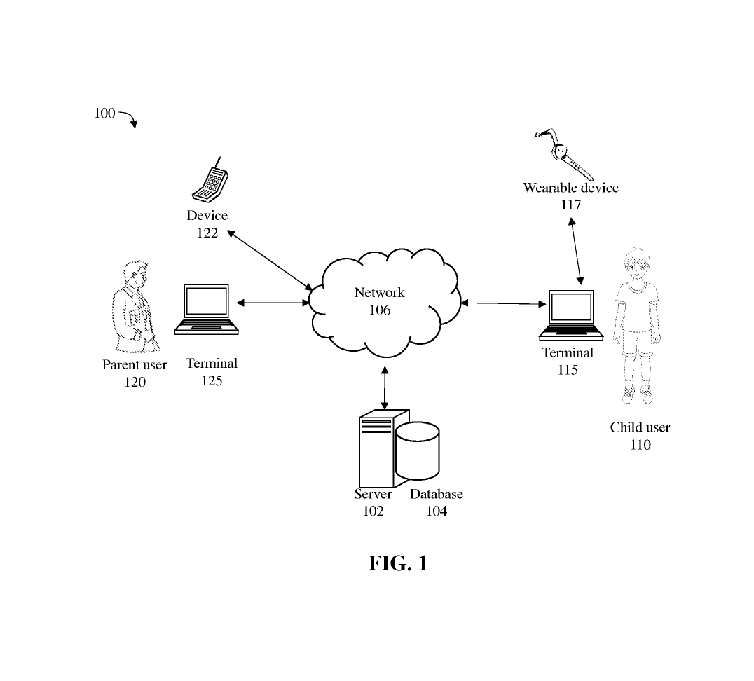

FIG. 1 is a diagram of an operating environment or system 100 that supports an application on a computing device for restricting IP access based upon personal performance coupled to a communications network 106, according to an example embodiment. In this document, restriction of IP access refers to restricting access to the Internet Protocol processes on a device (such as device 115), which effectively restricts the ability of the device 115 to communicate in any form via the network 106. The environment 100 may comprises terminals 115, 125, device 122, wearable device 117 and server 102, all of which may communicate with server 102 via a communications network 106. Terminals 115, 125, device 122, wearable device 117 and server 102 may comprise any computing device, such as work stations, integrated circuits, printed circuit boards, processors, ASICs, PCBs, cellular telephones, smart phones, tablet computers, desktop computers, laptops, and game consoles, for example. Additionally, the wearable device 117 may communicate via radio frequency or vendor application. The wearable device may include wearable technology, fashionable technology, wearable devices, tech togs, or fashion electronics such as clothing and accessories incorporating computer and advanced electronic technologies.

Terminals 115, 125, device 122, server 102 and wearable device 117 may be connected either wirelessly or in a wired or fiber optic form to the communications network 106. Communications network 106 may one or more packet switched networks, such as the Internet, or any local area networks, wide area networks, enterprise private networks, cellular networks, phone networks, mobile communications networks, or any combination of the above. In one embodiment, terminals 115, 125, device 122, and wearable device 117 may be a programmable logic controller or PLC.

Server 102 includes a software engine that delivers applications, data, program code and other information to networked terminals 115, 125. The software engine of server 102 may perform other processes such as transferring multimedia data in a stream of packets that are interpreted and rendered by a software application as the packets arrive. FIG. 1 further shows that server 102 includes a database or repository 104, which may be a relational database comprising a Structured Query Language (SQL) database stored in a SQL server or a database that adheres to the noSQL paradigm. Mobile computing device 122 and wearable device 117 may also each include databases. The database 104 may serve data, as well as related information, used by server 102 and terminals 115, 125, device 122 and wearable device 117 during the course of operation of the invention.

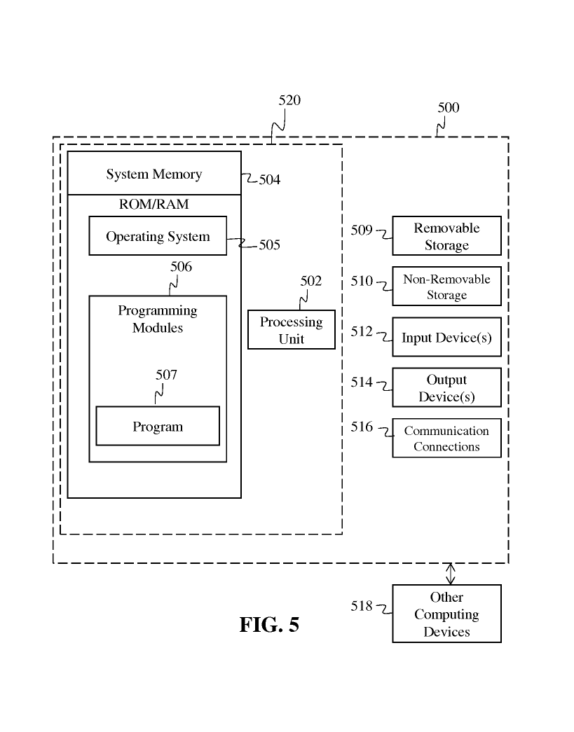

Terminals 115, 125, device 122, wearable device 117 and server 102 may each include program logic comprising computer source code, scripting language code or interpreted language code that perform various functions of the disclosed embodiments. In one embodiment, the aforementioned program logic may comprise program module 507 in FIG. 5. It should be noted that although FIG. 1 shows only one parent user terminal 125, one mobile device 122, one child user terminal 115, one wearable device 117 and one server 102, the system of the disclosed embodiments support any number of terminals, servers, mobile devices and wearable devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

Various types of data may be stored in the database 104 of server 102. For example, the database 104 may store one or more restriction input data associated with each parent user 120. Restriction input can be input using a graphical interface of terminals 115 or 125 from a parent user of the application. The restriction input may include a definition of a physical activity threshold, a definition of an educational activity threshold, a description of accepted content, a time access limit (defined by a number of hours, minutes, seconds), a time access exception period (defined as a specified time and date until a further time and date), and a countdown time limit (defined by a number of hours, minutes, seconds).

The definition of a physical activity threshold is defined by the parent user 120. The physical activity threshold may include a minimum amount of time that a child user 110 is required to exercise, the minimum intensity level of exercise required, the minimum type of exercise required, any combination of the above, or the like. The physical activity threshold may further be defined as a number of steps taken, an amount of time at a predefined heart rate, a distance walked/run, an amount of wattage output, an amount of calories burned, any combination of the above, or the like.

The definition of an educational activity threshold is defined by the parent user 120. The educational activity threshold may include a minimum amount of time that a child user 110 is required to interact with an educational application on device 115, the minimum level that must be reached on the application, the minimum type of educational exercises required, a minimum amount of time a child user is required to study, the type of studying that the child user is required to study, any combination of the above, or the like.

A description of accepted content may also be defined by the parent user and is content that a parent user deems acceptable for a child to have access to. A parent user may determine the type of content acceptable for the child user to view or access via the communications network. For example, the parent user may define the accepted content as only educational content. The restriction input may include a description of accepted content as defined by an indicator from a content rating system.

A time access limit may also be defined by the parent user. The time access limit is the maximum amount of time that a child user is permitted access to the communications network or device for a certain predetermined time or time access period. For example, the parent user may define the time access limit as 1.5 hours of time within a 24-hour period (time access period) for access to the communications network or device.

A time access exception is the period of time during the day that the parent user deems to be unacceptable for a child user to have access to a communications network or device. For example, a parent may deem that it is unacceptable to have access to the communications network or device from the hours of 8 PM to 6 AM. This will depend on the parent user's preference and individual child user.

A countdown timer limit may also be defined by the parent user and stored in the database 104 of server 102. A countdown timer limit may be defined as the maximum amount of time that a child user may have continuous access to the communications network or device. For example, the parent user may define or establish that the countdown timer limit for continuous use of the communications network or device may be 0.5 hours, while the time access limit within a 24-hour period is 1.5 hours. In such an example, a child user would be only allowed to have three continuous sessions of up to 0.5 hours within a 24-hour time access period.

Credential input may also be stored in the database 104 of the server. Credential input may include a parent user identifier, a parent user encryption code and a parent user contact address. The parent user identifier may be an alphanumeric value that is the unique to a particular parent user and/or parent user terminal. The parent user encryption code may include an alphanumeric value that is the unique to a particular parent user and/or parent user terminal and associated with the parent user identifier. A parent user contact address may include name, address, telephone number, email address, etc.

The wearable device 117 may include devices that can be worn on the child user's person and is formatted to read and store a plurality of physical activity data associated with the physical activity performed by the child user within in a certain time period. By way of example and not limitation, such physical activity data may include an amount of calories burned, type of physical activity, length of time dedicated to physical activity, intensity of physical activity, etc. Such information may be transmitted via radio frequency or vendor application to a reception module associated with the application on the computing device 115.

In one embodiment, device 115 may comprise an educational application or applications with which the child user may interact. The application may log the child's activity, such as the amount of time that a child user 110 interacts with the educational application on device 115, the minimum level that was reached on the application, the type of educational exercises used, etc. Later, the educational activity that was logged may be used by application on the server to determine whether the child use may be provided with IP access.

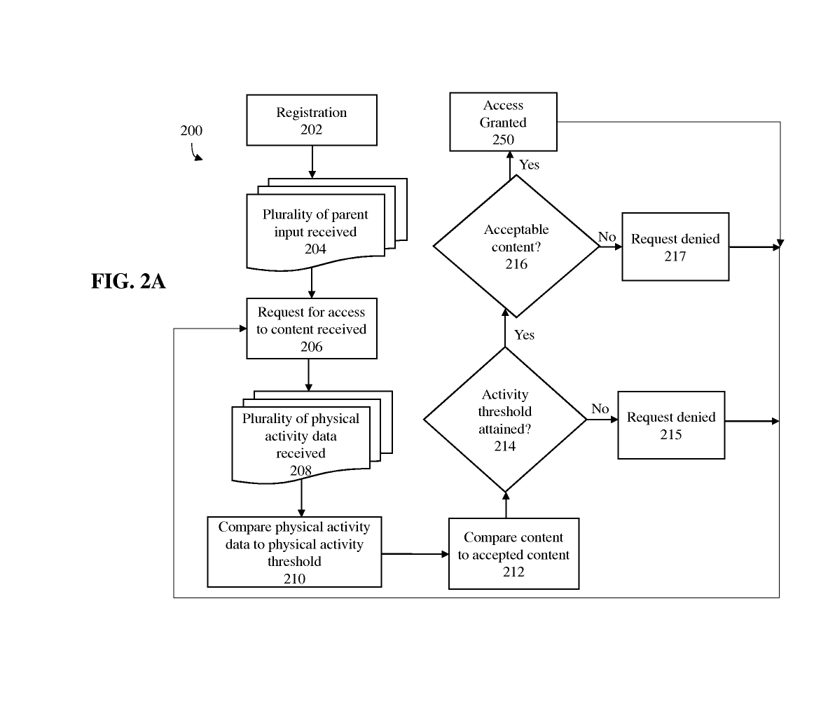

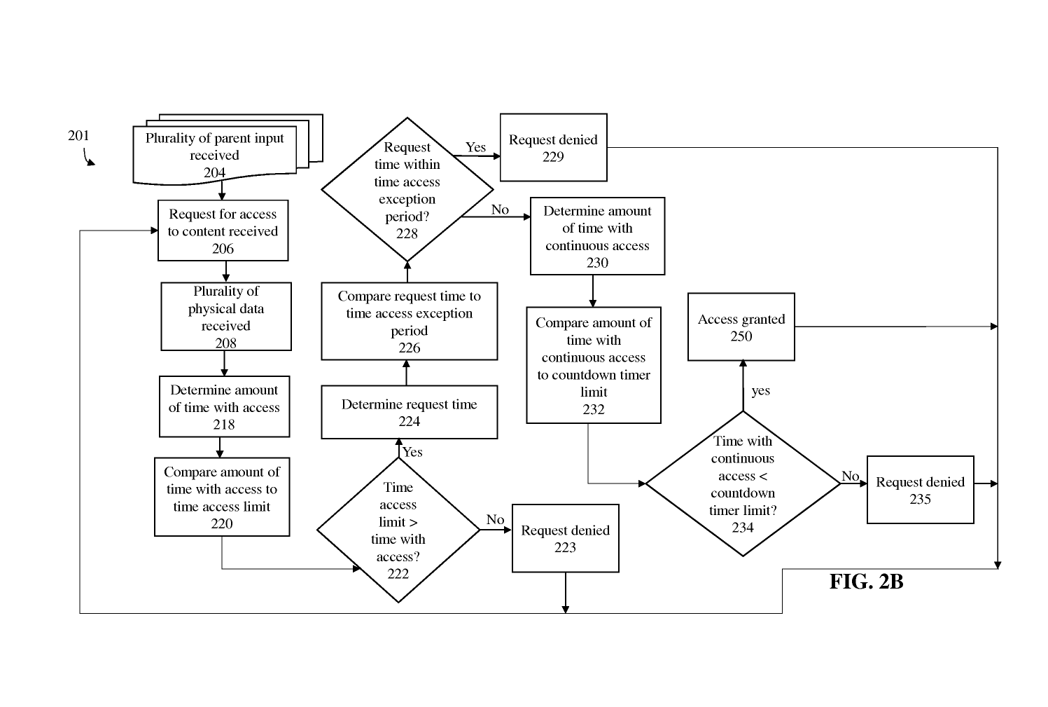

FIG. 2A is a flow chart showing the control flow of the process 200 performed by the main components of the application on a computing device communicatively coupled to a communications network 106. In step 202, the parent user registers for use of the application. This may include purchase for, and download of, the application on a computing device 125 as well as entering a plurality of personal identification data. Next, in step 204, the parent user 120 enters via the graphical user interface of the terminal or computing device 125, a plurality of parent input. The parent input includes the restriction input and may also include the credential input of the parent user. In the present embodiment, the restriction input includes a definition of a physical activity threshold, an educational activity threshold and/or a definition of accepted content. At this point, the parent may also define an acceptable physical activity threshold, an acceptable educational activity threshold and what is accepted content. The parent may also define additional restriction input such as the definition of a time access limit, the definition of a time access exception, what is the countdown timer limit. The parent user may also define the credential input such as the parent user identifier, the parent user encryption code and the parent user contact address.

Next, in step 206, the child user 110 requests, via a graphical user interface of terminal 115, access to particular content on the communications network 106. An access control module configured for receiving such requests, receives the child user's request for access. In step 208, a reception module configured for receiving, via radio frequency or vendor application, physical activity data from the wearable computing device 117 worn by the child user, receives a plurality of physical activity data from the wearable computing device. In one embodiment, in step 208, the reception module also receives educational activity data of the child user that was logged by device 115.

Next, in step 210, the access control module, which is configured for comparing the received physical activity data from the wearable computing device to the physical activity threshold defined by the parent user, compares the received physical activity data from the wearable computing device to the physical activity threshold defined by the parent user. In one alternative, in step 210, the access control module, compares the logged educational activity data from device 115 to the educational activity threshold defined by the parent user. Next, as illustrated in step 212, the access control module, which is also configured for comparing the particular content that the child user is requesting access to with definition of the accepted content as defined by the parent user, compares the particular content that the child user is requesting access to with definition of the accepted content.

Next, in step 214, the access control module, which is configured for determining whether the physical activity threshold (or the educational activity threshold) has been met, determines whether the physical activity threshold (or the educational activity threshold) has been met. If the threshold has not been attained or met, the child user's request for access to the communications network is denied as illustrated in step 215. If the threshold has been attained, then the access control module then determines whether the content the child user intends to view is acceptable based upon the accepted content definition. If the content is not acceptable, then the request is denied, as shown in step 217. If the content is acceptable, then access can be granted, as illustrated in step 250. As shown in steps 215 and 217, if a request is denied, the access control module reverts or directs the control flow back to step 206. Additionally, after access is granted in step 250, the access control module can continuously and in real time move the process flow back to step 206. Thus, a child user is not able to obtain the access to the communications network 106 only once, but is continuously required to have access granted by the access control module.

FIG. 2B is a flow chart showing the overall control flow of the process 201 performed by the main components of the application on a computing device communicatively coupled to a communications network 106. The plurality of steps of the control flow illustrated in FIG. 2B may also be utilized in conjunction or alternatively with the steps of the control flow illustrated in FIG. 2A. After having registered as explained in step 202 in FIG. 2A, in step 204, the parent user 120 inputs into a graphical interface a plurality of parent input. The parent input includes a plurality of restriction input. The restriction input includes definitions defined by the parent user of a time access limit, a time access exception and a countdown timer limit.

In step 206, the access control module, which is configured for receiving a request from the child user 110 via a graphical interface, receives a request from the child user for access to content. As in FIG. 2A, in step 208, the reception module, which is configured for receiving, via radio frequency or vendor application, physical activity data from a wearable computing device worn by a child user, receives a plurality of physical activity data from the wearable computing device. Also in step 208, the reception module may receive or retrieve educational activity that was previously stored (see above).

The access control module is further configured for determining the amount of time the child or user has accessed content within a time access period. As mentioned above, a time access period is a predetermined amount of time that can be defined by the parent user. In step 218, the access control module determines the amount of time the child user has accessed content within a time access period. Next, in step 220, the access control module, which is further configured for comparing the time access limit to the amount of time the child user has accessed content within the time access period, compares the time access limit to the amount of time the child user has access content within the time access period. Next, in step 222, the access control module, which is also configured for determining if the amount of time the child user has accessed content within the time access period is greater or less than the time access limit, determines if the time access limit is greater than the amount of time the child user has accessed content within the time access period. If the time access limit defined by the parent user is not greater than the amount of time the child user has accessed content within a time access period, then the request to access content is denied as shown in step 223. If the amount of time the child user has accessed content within a time access period is less than the time access limit defined by the parent user, then the control flow moves to step 224.

The access control module is also configured for determining a request time the child user requests via the graphical user interface of terminal 115 access to content. The request time is the actual time of day and date that the child user requests access. In step 224, the access control module, which is further configured for determining a request time the child user requests access to content, determines a request time the child user requests access to content. Next, in step 226, the access control module, which is further configured for comparing the time access exception period to the request time, compares the request time to time access exception period. As mentioned above, the time access exception period is defined as the day and time that the child user is not permitted access to the communications network. In step 228, the access control module, which is configured for determining whether the request time falls within the time access exception period, determines whether the request time falls within the time access exception period. If it does, then the request for access is denied as shown in step 229. If it does not, then the control flow moves to step 230.

The access control module is also further configured for counting the amount of time the child user has continually had access to content on the communications network. In step 230, the access control module determines the amount of time the child user has continuously accessed content on the communications network. Next, in step 232, the access control module, which is also configured for comparing the amount of time the child user has continuously accessed content to the countdown timer limit. As mentioned above, a countdown timer limit may be defined as the maximum amount of time that a child user may have continuous access to the communications network or device. Next, in step 234, the access control module, which is also configured for determining if the amount of time with continuous access is greater than or less than the countdown timer limit, determines if the time with continuous access is less than the countdown timer limit. If the time with continuous access is less than the countdown timer limit, then the process flow moves to step 250 and access to the communications network can be granted. If not, then the request for access is denied, as shown in step 235. It should be noted that various combinations of the processes 200 and 201 are contemplated. Further, the parent user may choose to include certain steps while not to include certain steps based upon personal preference. It should also be noted that in steps 223, 229 and 235, after access has been denied, the process flow may revert back to step 206 where the request for access to content is received. Additionally, after step 250 when access is granted, the control flow reverts back to step 206 allowing the application to continuously monitor whether or not the child user has met the requirements set or defined by the parent user.

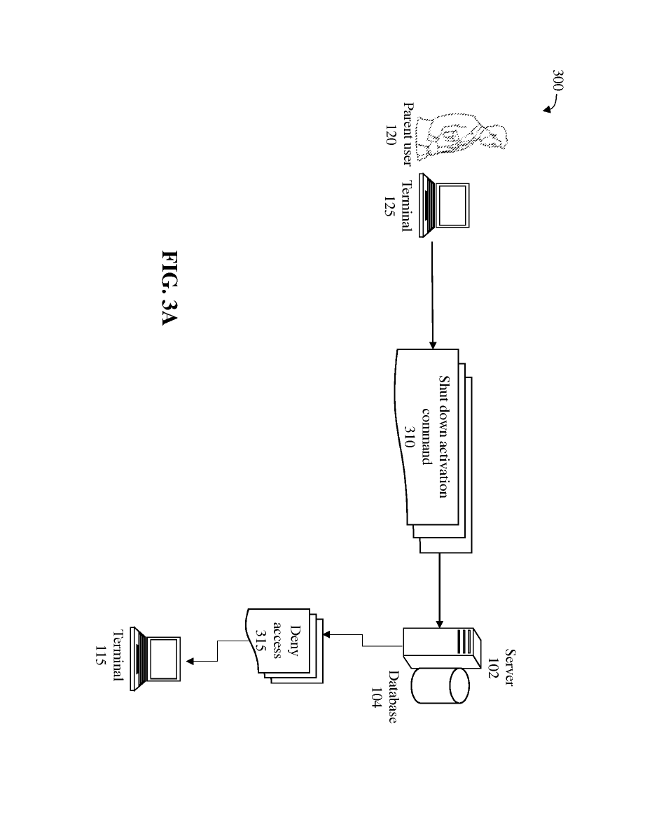

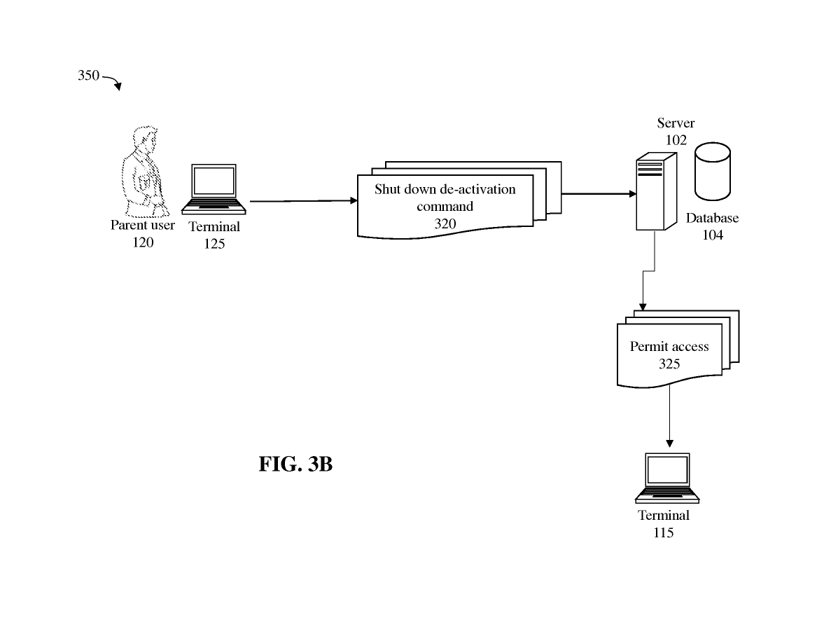

FIGS. 3A and 3B are diagrams showing the data flow 300 and 350, respectively, of an application on a computing device for restricting IP access over the communications network, according to other example embodiments. FIG. 3A illustrates the data flow 300 of how the application allows the parent user 120 to unilaterally shut down or deny access on terminal 115 to content accessed from the communications network. The graphical user interface of terminal 125 or device 122 is further configured for receiving a shutdown input from the parent user. The shutdown input includes a shutdown activation command and a shutdown deactivation command. As shown in FIG. 3A, the graphical user interface of the terminal 125 receives a shutdown activation command 310. The access control module is further configured for receiving, via the communications network, the shutdown activation command from the parent user. Then, the communications network communicates the shutdown activation command to the access control module, which receives the shutdown activation command. After receiving the shutdown activation command from the parent user, the access control module denies (via message 315) terminal 115, used by the child user, access to the communications network after receiving the shutdown activation command.

FIG. 3B illustrates data flow 350, which is one embodiment of how the application allows the parent user to unilaterally reactivate or allow terminal 115 access to content on the communication network. As shown in FIG. 3B, the graphical user interface of the terminal 125 receives the shutdown deactivation command 320 from the parent user. The access control module is further configured for receiving, via the communications network, the shutdown deactivation command from terminal 125. Then, the communications network communicates the shutdown deactivation command to the access control module, which receives the shutdown deactivation command. After receiving the shutdown deactivation command from terminal 125, the access control module grants or allows (via message 325) terminal 115, which is utilized by the child user, access to the communications network after receiving the shutdown deactivation command.

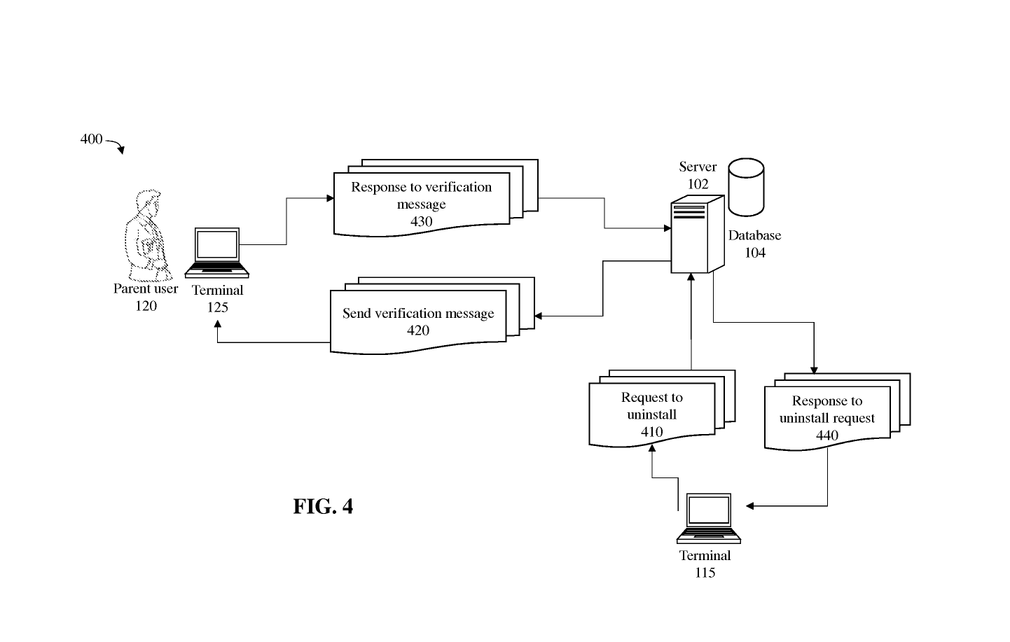

FIG. 4 is a diagram showing the data flow 400 of a process of an application on a computing device for restricting IP access over the communications network, according to another example embodiment. Control flow 400 is the process used for uninstallation of the application. It should be noted that the server 102 is further configured for receiving credential input from the parent user of the application. Credential input may include a parent user identifier, a parent user encryption code and a parent user contact address. The application further includes an uninstallation module configured for, receiving, from the graphical user interface, a request for uninstallation. In FIG. 4, a request to uninstall 410 is received at terminal 115. The uninstallation module is also configured for sending and sends, via the communications network, a verification message 420 to the parent user contact address. The verification message may be sent via HTTP and may be provided to the parent user 120 by electronic mail, instant messaging or text messaging etc. The uninstallation module is further configured to wait for a certain predetermined response time for a response from the parent user contact address. The predetermined response time may be defined by the parent user and may also be included in the credential input. If a response is not received within the predetermined response time, then the application may determine such lack of response as an invalid response to a verification message. The verification message may require the parent user to enter, via the graphical user interface, of terminal 125 a response having a user identifier and encryption code having the same values as the user identifier and encryption code defined by the parent user's credential input. If the parent user desires for the application to be uninstalled, then the parent user may enter into the graphical user interface at terminal 125, a response to the verification message 430 having an encryption code and user identifier with the same values as the encryption code and user identifier defined in the credential input. If the parent does not desire the application to be uninstalled, then the parent user may not respond or may begin the process 300 for unilateral deactivation. In step 440, the response to the verification a message is received, via the communications network, by the uninstallation module. If the response to the verification message includes values of the user identifier and user encryption code equal to those defined by the credential input then the request to uninstall is granted. If the response to the verification message does not include values of the user identifier and user encryption code equal to those defined by the credential input then the request to uninstall is denied.

FIG. 5 is a block diagram of a system including an example computing device 600 and other computing devices. Consistent with the embodiments described herein, the aforementioned actions performed by terminal 115, 215, server 102, device 122 and wearable device 117 may be implemented in a computing device, such as the computing device 500 of FIG. 5. Any suitable combination of hardware, software, or firmware may be used to implement the computing device 500. The aforementioned system, device, and processors are examples and other systems, devices, and processors may comprise the aforementioned computing device. Furthermore, computing device 500 may comprise an operating environment for the processes depicted in 200, 201, 300, 350, and 400 as described above. The processes depicted in 200, 201, 300, 350, and 400 may operate in other environments and are not limited to computing device 500.

With reference to FIG. 5, a system consistent with an embodiment of the invention may include a plurality of computing devices, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination or memory. System memory 504 may include operating system 505, and one or more programming modules 506. Operating system 505, for example, may be suitable for controlling computing device 500's operation. In one embodiment, programming modules 506 may include, for example, a program module 507 for executing the actions of server 102 and terminals 115, 125, device 122 and wearable device 117, for example. Furthermore, embodiments of the invention may be practiced in conjunction with a graphics library, other operating systems, or any other application program and is not limited to any particular application or system. This basic configuration is illustrated in FIG. 5 by those components within a dashed line 520.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a camera, a touch input device, etc. Output device(s) 514 such as a display, speakers, a printer, etc. may also be included. The aforementioned devices are only examples, and other devices may be added or substituted.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 504, including operating system 505. While executing on processing unit 502, programming modules 506 (e.g. program module 507) may perform processes including, for example, one or more of the stages of the process 500 as described above. The aforementioned processes are examples, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An application on a computing device communicatively coupled to a communications network, comprising:
a graphical interface for receiving restriction input from a parent user of the application, wherein the restriction input includes a definition of a physical activity threshold and a definition of accepted content;
a reception module configured for receiving, via radio frequency or vendor application, physical activity data from a wearable computing device worn by a child user;
an access control module configured for:
receiving a request from the child user, via a graphical interface, to access particular content on the communications network;
comparing the received physical activity data from the wearable computing device to the physical activity threshold and determining whether the physical activity threshold has been met;
comparing the particular content to the definition of accepted content and determining whether the particular content comprises accepted content; and
wherein if the physical activity threshold has been met and if the particular content comprises accepted content, providing to the child user access to the particular content on the communications network.

2. The application of claim 1, wherein the restriction input further includes a definition of a time access limit and wherein the access control module is further configured for a) determining the amount of time the child user has accessed content within a time access period b) comparing the time access limit to the amount of time the child user has accessed content within the time access period c) determining if the amount of time the child user has accessed content within the time access period is greater than the time access limit, d) providing to the child user access to content on the communications network if the amount of time the child user has accessed content within the time access period is less than the time access limit.

3. The application of claim 1, wherein the restriction input further includes a definition of a time access exception period and wherein the access control module is further configured for a) determining a request time the child user requests access to content b) comparing the time access exception period to the request time, c) determining if the request time is within the time access exception period, d) providing to the child user access to content on the communications network if the request time is not within the time access exception period.

4. The application of claim 1, wherein the restriction input further includes a countdown timer limit, and wherein the access control module is further configured for a) counting an amount of time a child user has continuously accessed content, b) comparing the countdown timer limit to the amount of time the child user has continuously accessed content, c) determining if the amount of time the child user has continuously accessed content is greater than the countdown timer limit, and d) allowing to the child user access to content if the amount of time the child user has continuously accessed content is less than the countdown time limit.

5. The application of claim 1, wherein the graphical user interface is further configured for receiving a shutdown input from the parent user of the application, wherein a shutdown input includes a shutdown activation command and a shutdown deactivation command, and wherein the access ac module is further configured for a) receiving, via the communications network, the shutdown activation command from the parent user, b) denying a device used by the child user access to the communications network after receiving the shutdown activation command, c) receiving, via the communications network, the shutdown deactivation command from the parent user, and d) permitting a device used by the child user access to the communications network after receiving the shutdown deactivation command.

6. The application of claim 1, wherein the graphical user interface is further configured for receiving credential input from a parent user of the application, wherein the credential input includes a parent user identifier, a parent user encryption code, a parent user contact address, and wherein the application further includes an uninstallation module configured for a) receiving, from the graphical interface, a request for uninstallation, b) sending, via the communications network, a verification message to the parent user contact address requesting a response with the user identifier and encryption code, c) waiting for a predetermined response time for a response from the parent user contact address, d) receiving, via the communications network, a response, e) determining if the response was received within the predetermined response time and includes the correct user identifier and encryption code, and f) permitting uninstallation of the application from the computing device if the response includes the correct user identifier and encryption code.

7. The application of claim 6, wherein the verification message is sent via HTTP.

8. The application of claim 6, wherein the verification message is provided to the parent user by electronic mail.

9. The application of claim 6, wherein the verification is provided to the parent user by instant messaging.

10. The application of claim 6, wherein the verification is provided to the parent user by text messaging.

11. An application on a computing device communicatively coupled to a communications network, comprising:
a graphical interface for receiving restriction input from a parent user of the application, wherein the restriction input includes a) a definition of a physical activity threshold, b) a definition of accepted content, c) a time access limit, d) a time access exception period, and e) a countdown timer limit;
a reception module configured for:
receiving, via radio frequency or vendor application, physical activity data from a wearable computing device worn by a child user;
an access control module configured for:
a) receiving a request from the child user, via a graphical interface, to access particular content on the communications network;
b) comparing the received physical activity data from the wearable computing device to the physical activity threshold and determining whether the physical activity threshold has been met;
c) comparing the particular content to the definition of accepted content and determining whether the particular content comprises accepted content;
d) determining the amount of time the child user has accessed content within a time access period;
e) comparing the time access limit to the amount of time the child user has accessed content within the time access period;
f) determining if the amount of time the child user has accessed content within the time access period is greater than the time access limit;
g) determining a request time the child user requests access to content;
h) comparing the time access exception period to the request time;
i) determining if the request time is within the time access exception period;
j) counting an amount of time a child user continuously accessed content;
k) comparing the countdown timer limit to the amount of time the child user has continuously accessed content;
l) determining if the amount of time the child user has continuously accessed content is greater than the countdown timer limit, and
m) providing to the child user access to the particular content on the communications network if 1) the physical activity threshold has been met, 2) the particular content comprises accepted content, 3) the request time is not within the time access exception period, 4) the amount of time the child user has accessed content within the time access period is less than the time access limit, 5) the amount of time the child user has continuously accessed content is less than the countdown time limit.

12. The application of claim 11, wherein the graphical user interface is further configured for receiving a shutdown input from the parent user of the application, wherein a shutdown input includes a shutdown activation command and a shutdown deactivation command, and wherein the access control module is further configured for a) receiving, via the communications network, the shutdown activation command from the parent user, b) denying a device used by the child user access to the communications network after receiving the shutdown activation command, c) receiving, via the communications network, the shutdown deactivation command from the parent user, and d) permitting a device used by the child user access to the communications network after receiving the shutdown deactivation command.

13. The application of claim 11, wherein the graphical user interface is further configured for receiving credential input from a parent user of the application, wherein the credential input includes a parent user identifier, a parent user encryption code, a parent user contact address, and wherein the application further includes an uninstallation module configured for a) receiving, from the graphical interface, a request for uninstallation, b) sending, via the communications network, a verification message to the parent user contact address requesting a response with the user identifier and encryption code, c) waiting for a predetermined response time for a response from the parent user contact address, d) receiving, via the communications network, a response, e) determining if the response was received within the predetermined response time and includes the correct user identifier and encryption code, and f) permitting uninstallation of the application from the computing device if the response includes the correct user identifier and encryption code.

14. The application of claim 13, wherein the verification message is sent via HTTP.

15. The application of claim 13, wherein the verification message is provided to the parent user by electronic mail.

16. The application of claim 13, wherein the verification is provided to the parent user by instant messaging.

17. The application of claim 13, wherein the verification is provided to the parent user by text messaging.

18. An application on a computing device communicatively coupled to a communications network, comprising:
a graphical interface for 1) receiving restriction input from a parent user of the application, wherein the restriction input includes a definition of an educational activity threshold and a definition of accepted content, and 2) for receiving credential input from a parent user of the application, wherein the credential input includes a parent user identifier, a parent user encryption code, a parent user contact address,
a reception module configured for logging educational activity data of a child user;
an access control module configured for:
receiving a request from the child user, via a graphical interface, to access particular content on the communications network;
comparing the stored educational activity data to the educational activity threshold and determining whether the educational activity threshold has been met;
comparing the particular content to the definition of accepted content and determining whether the particular content comprises accepted content; and
wherein if the educational activity threshold has been met and if the particular content comprises accepted content, providing to the child user access to the particular content on the communications network.

19. The application of claim 18, wherein the educational activity threshold comprises interacting with an educational application for a predefined period of time.

20. The application of claim 18, wherein the educational activity threshold comprises attaining a predefined level on an educational application.
